(19) United States
(12) Patent Application Publication
(10) Pub. No.: US 2018/0144337 A1
(43) Pub. Date: May 24, 2018

(54) NFC PAIRED BLUETOOTH E-COMMERCE

(71) Applicant: MasterCard Mobile Transactions Solutions, Inc., Purchase, NY (US)

(72) Inventors: Nehal Maniar, Oak Brook, IL (US); Douglas J. Morgan, Reno, NV (US)

(21) Appl. No.: 15/873,150

(22) Filed: Jan. 17, 2018

Related U.S. Application Data
(63) Continuation of application No. 14/291,687, filed on May 30, 2014.
Application No. 14/291,687 is a continuation-in-part of application No. 13/909,262, filed on Jun. 4, 2013.
Application No. 13/909,262 is a continuation of application No. 13/651,028, filed on Oct. 12, 2012, now abandoned.
(60) Provisional application No. 61/829,705, filed on May 31, 2013.
(60) Provisional application No. 61/546,084, filed on Oct. 12, 2011.
(60) Provisional application No. 61/619,751, filed on Apr. 3, 2012.

(51) Int. Cl. G06Q 20/36; G06Q 30/06; G06Q 20/40; G06Q 20/38; H04W 4/80; G06Q 20/32; G06Q 20/10; G06Q 20/08

(52) U.S. Cl. CPC G06Q 20/36; G06Q 30/06; G06Q 20/40; G06Q 20/382; G06Q 20/3674; G06Q 20/3278; G06Q 20/325; G06Q 20/322; G06Q 20/105; G06Q 20/08; H04W 4/80

(57) ABSTRACT

A method for performing an electronic transaction over two distinct networks with a mobile wallet comprises the steps of receiving form of payment information from a mobile wallet over a first wireless network of a retail environment with a mobile device on which the mobile wallet is deployed; sending second wireless network description information of the retail environment over the first wireless network to facilitate access to the second wireless network by the mobile device, wherein the first wireless network operates within access range of the second wireless network; sending service information from a service provider associated with the retail environment over the second wireless network to request execution of a service provider-specific widget on the mobile device; and completing the electronic transaction, that was initiated by receiving the default form of payment information, by exchanging payment confirmation information over the second network via the service provider-specific widget.

### CROSS REFERENCE TO RELATED APPLICATIONS

This application is a continuation U.S. patent application Ser. No. 14/291,687 (Attorney Docket No. CSAM-0007-U01), filed May 30, 2014, entitled “NFC PAIRED BLUETOOTH E-COMMERCE”.

U.S. patent application Ser. No. 14/291,687 claims the benefit of U.S. application Ser. No. 61/829,705 (Attorney Docket No. CSAM-0007-P01), filed May 31, 2013.

U.S. patent application Ser. No. 14/291,687 is a continuation-in-part of U.S. patent application Ser. No. 13/909,262 (Attorney Docket No. CSAM-0005-U01-001), filed Jun. 4, 2013, entitled “A SECURE ECOSYSTEM INFRASTRUCTURE ENABLING MULTIPLE TYPES OF ELECTRONIC WALLETS IN AN ECOSYSTEM OF ISSUERS, SERVICE PROVIDERS, AND ACQUIRES OF INSTRUMENTS”. U.S. patent application Ser. No. 13/909,262 is a continuation of U.S. patent application Ser. No. 13/651,028 (Attorney Docket No. CSAM-0005-U01), filed Oct. 12, 2012 and now abandoned, entitled “A MULTI-TIERED SECURE MOBILE TRANSACTIONS ENABLING PLATFORM”.

U.S. patent application Ser. No. 13/651,028 also claims the benefit of U.S. provisional patent application 61/546,084 (Attorney Docket No. CSAM-0002-P01), filed Oct. 12, 2011 and U.S. provisional patent application 61/619,751 (Attorney Docket No. CSAM-0004-P01), filed Apr. 3, 2012.

### BACKGROUND

### Field

This application generally relates to mobile transaction processing security and more particularly relates to methods and systems of a multi-network transaction environment based on a multi-tier mobile transaction platform for secure personalized transactions in a multi-domain ecosystem.

### Description of the Related Art

Mobile transactions are becoming a prevalent form of point of sale payments. Existing systems for mobile transaction processing do not have the scalability and flexibility of configurability needed to address the ever growing demand for secure personalized transaction services and client contact to meet future business needs.

### SUMMARY

Near Field Communication (NFC) based payment systems may provide a means for quickly transferring form-of-payment related information from a handheld device (e.g. an NFC-enabled mobile phone) to a point of sale apparatus. While this may ensure that a financial transaction can be completed in an electronic commerce/payment system even after the phone has been moved out of NFC range (generally less than four centimeters), the user cannot receive a receipt or confirmation of payment over the NFC link without holding the phone within NFC range for several seconds or bringing the phone within NFC range again after the backend payment process has been completed.

Bluetooth wireless communication can occur over a much greater distance than NFC (ten meters or more compared to 4/100^{ths} of a meter), but it requires devices to be paired to communicate. This pairing typically takes more than several seconds and requires users to select from one of many devices in range.

Recently, using NFC as a medium for exchange of device-to-device information to facilitate Bluetooth pairing has been standardized. This allows a Bluetooth headset to be paired with a mobile phone thru the inclusion of an NFC tag in the headset, which is read by an NFC reader in the phone.

The universal electronic payment facilities, systems and methods described herein may take advantage of this coming together of short range (e.g. NFC) and longer range (e.g. Bluetooth) technologies to provide a short range payment user with single tap-and-go payment and receipt capabilities that no longer burden the user to require “tap-and-hold” or tap to pay and tap for receipt. In an example, NFC tap-to-pay may be combined with Bluetooth or other longer-range wireless receipt delivery when Bluetooth pairing or other wireless authentication is combined with an NFC “tap”. Alternatively, an NFC tap and pair may indicate a commitment to pay for a transaction and through the longer-range wirelessly paired network may enable processing the committed payment and delivering a receipt completely after the NFC tap and commit. These types of scenarios that are enabled by short-range wireless authentication for longer-range wireless access are explored further.

Methods and systems of a multi-network transaction platform may include a personalization tier of a multi-tier platform for secure personalized transactions, the personalization tier configured to enable a service provider to personalize near field communication (NFC) information to enable authentication onto a local wireless network by a mobile device that receives the personalized NFC information from an NFC terminal via an NFC tap while in access range of the local wireless network, wherein the personalized NFC information indicates at least one service provider-specific widget to be executed on the mobile device upon authentication onto the local wireless network. The personalized NFC information may further include a preferred wireless network for communicating between the service provider-specific widget and the service provider. The personalized NFC information may further include a required wireless network for communicating between the service provider-specific widget and the service provider. The personalization tier may include a software development kit for developing the service provider-specific widget.

Methods and systems of a multi-network transaction platform may include a multi-tier personalized transaction platform that may include a user interface; a service provider; a service provider server configured with software that is adapted to enable personalizing service elements that facilitate over the air service delivery to a user of a mobile phone; a personalization tier; a service tier; and an enabling tier.

Methods and systems of a multi-network transaction platform may include a service tier of a multi-tier platform for secure personalized transactions, the service tier configured to enable service delivery from a service provider to a user of a mobile device via a local wireless network that the mobile device is authenticated to use through receipt of service provider and local wireless network information during an NFC tap operation between the mobile device and an NFC terminal that is in access range of the local wireless network. The service tier may comprise reference implementations of finance, retail, health, and government domains. The service tier may comprise a client-side workflow for a plurality of transaction service types, an instrument that facilitates mapping to real world instruments, and a trust model to facilitate two factor authentication.

Methods and systems of a multi-network transaction platform may include an enabling tier of a multi-tier platform for secure personalized transactions, the enabling tier operable on a mobile device to enable delivery of service provider and local wireless network information to a wallet container application executing on the mobile device, the service provider and local wireless network information received by the mobile device during an NFC tap operation between the mobile device and an NFC terminal that is in access range of the local wireless network. The enabling tier may comprise an application that operates cooperatively with a wallet container application adapted for execution on a plurality of different types of mobile devices. The wallet container application may enable an electronic wallet capability on the client device by abstracting client-specific runtime environment features. The enabling tier may include a client runtime component adapted for execution on a mobile device. The client runtime component may be a client independent application that interoperates with client specific resources via a client independent API layer. The client runtime component may comprise at least one of a widget management module, a user interface framework, and an action framework. The client runtime component may enable distinct operation of a plurality of electronic wallets via a wallet container module. The client runtime component may abstract client specific runtime environment features to enable a wallet capability.

Methods and systems of a multi-network transaction platform may include a method of multi-network tokenization for electronic transaction security that may include receiving form of payment information from a mobile wallet by an NFC terminal for performing an electronic transaction; generating a tokenized representation of the information; sending a token identifier of the tokenized representation and wireless local area network authentication information to the mobile wallet from the NFC terminal; forwarding the tokenization representation to a service provider for processing the electronic transaction; receiving information from the mobile device over the wireless local area network that associates the tokenized representation with the mobile device; and forwarding a tokenized confirmation that is identifiable by the token identifier and that is received from the service provider to the mobile device over the local area wireless network.

Methods and systems of a multi-network transaction platform may include an NFC capable mobile wallet that activates a service provider-specific set of widgets to provide services via the widgets over a specific wireless network to a mobile device in response to receiving the specific wireless network identification information via an NFC interaction. The specific wireless network may have previously been unknown to the wallet capability. The wallet container application operating cooperatively with the mobile wallet may update a table that cross references wireless network identification with service provider-specific widgets to facilitate activating the service provider-specific set of widgets each time the specific wireless network is detected.

Methods and systems of a multi-network transaction platform may include a quick response code (QR code) decoding-capable mobile wallet that activates a service provider-specific set of widgets for a mobile device in response to determining local wireless network identification information from a QR code captured while the mobile wallet is in access range of the local wireless network.

Methods and systems of a multi-network transaction platform may include a method may include: receiving wireless network identification data for a service provider-specific network via an NFC tap function; using an NFC capable electronic wallet to associate the network identification data with a service provider-specific widget and activating the service provider-specific widget; storing the associated network identification data and a service provider-specific widget identifier for the service provider-specific widget in a network reference table in a memory of a mobile device; and referencing the network reference table when a wireless network is detected by the mobile device to determine a service provider-specific widget to activate. The network identification data may be a network SSID. Using an NFC capable electronic wallet may comprise providing the network identification data to a wallet container executing on the mobile device that associates the network identification data with the service provider-specific widget and facilitates activating the service provider-specific widget. Referencing the network reference table may be performed by a mobile wallet container executing on the mobile device that facilitates activating the service provider-specific widget based on a result of referencing the network reference table.

Methods and systems of a multi-network transaction platform may include a method for providing a service from a service provider to a user of a mobile device via a service provider-specific widget, wherein providing is performed over a private wireless network after authenticating access to the private wireless local area network using network authentication credentials delivered to a mobile wallet executing on the mobile device during an NFC tap of the mobile device with an NFC terminal that is disposed within access range of the private wireless local area network.

Methods and systems of a multi-network transaction platform may include a method for providing a service from a service provider to a user of a mobile device via a service provider-specific widget, wherein providing is performed over a private wireless network after authenticating access to the private wireless local area network using network authentication credentials received by a mobile wallet executing on the mobile device from a QR code captured by the mobile device while the mobile device is disposed within access range of the private wireless local area network.

Methods and systems of a multi-network transaction platform may include a method for performing an electronic transaction over two distinct networks with a mobile wallet, comprising: receiving form of payment information from a mobile wallet over a first wireless network of a retail environment with a mobile device on which the mobile wallet is deployed; sending second wireless network description information of the retail environment over the first wireless network to facilitate access to the second wireless network by the mobile device, wherein the first wireless network operates within access range of the second wireless network; sending service information from a service provider associated with the retail environment over the second wireless network to request execution of a service provider-specific widget on the mobile device; and completing the electronic transaction, that was initiated by receiving the default form of payment information, by exchanging payment confirmation information over the second network via the service provider-specific widget.

Methods and systems of a multi-network transaction platform may include a method for performing an electronic transaction over two distinct networks, comprising: sending form of payment information from a mobile wallet over a first wireless network with a mobile device on which the mobile wallet is deployed; receiving second network description information over the first wireless network; executing a service provider-specific widget on the mobile device in response to service information received over the second network; and completing the electronic transaction, that was initiated by sending the default form of payment information, by exchanging payment confirmation information over the second network via the service provider-specific widget.

Methods and systems of a multi-network transaction platform may include a method for performing an electronic transaction over two distinct networks, comprising: sending a form of payment information from a mobile wallet over a first wireless network with a mobile device on which the mobile wallet is deployed; receiving second network description information over the first wireless network; executing a service provider-specific widget on the mobile device based on service provider information derived from the second network description information; and completing the electronic transaction, that was initiated by sending the default form of payment information, by exchanging payment confirmation information over the second network via the service provider-specific widget. The first wireless network may be a near-field communication network. Sending the form of payment information may comprise: receiving a request to confirm a purchase; providing the request to the mobile wallet; accessing a default form of payment information from secure storage on the mobile device; and transmitting a representation of the form of payment over the first wireless network. Accessing a form of payment information from secure storage on the mobile device may include executing a mobile wallet companion applet that is authorized to access the secure storage and providing payment information to the mobile wallet. The form of payment information may include mobile wallet identification information suitable for identifying at least one service provider for completing the electronic transaction. Receiving second network description information may comprise receiving information to facilitate accessing the second network and for authentication of the mobile device to perform secure electronic transactions over the second network, wherein the second network is a secure local area wireless network. Executing a service provider-specific widget may include: determining which service provider-specific widget to execute based on the service information; loading the determined service provider-specific widget into a container executing on the mobile device; and executing the service provider-specific widget within a run-time environment provided by the container. Completing the electronic transaction may comprise using the service provider-specific widget to access a second form of payment information via the wallet and sending the second form of payment information for completing the transaction instead of the default form of payment information. The second form of payment information may be identified in the service information. The second form of payment information may be a default form of payment information associated with the service provider-specific widget. Completing the electronic transaction may comprise using the service provider-specific widget to facilitate confirmation of the electronic transaction by presenting a branded transaction confirmation request to the user of the mobile device and forwarding a user response thereto to a service provider from which the service information was received. Completing the electronic transaction may comprise using the service provider-specific widget to receive and store in the mobile wallet a branded receipt for the electronic transaction from a service provider from which the service information was received. This method may further include updating network availability status of the mobile wallet based on establishing a network connection using the second network between the mobile device and a remote service provider. The remote service provider may be an electronic transaction facilitator for a retail environment of the first and second networks. The second network may be one of Bluetooth and Wi-Fi.

Methods and systems of a multi-network transaction platform may include a method of commerce, comprising: receiving Bluetooth pairing information from a universal electronic transaction device during a near-field communication payment information exchange; during the near-field communication information exchange, delivering Bluetooth pairing information for at least one Bluetooth-enabled device other than the universal electronic transaction device to the universal electronic transaction device to facilitate Bluetooth pairing of the at least one Bluetooth-enabled device and the universal electronic transaction device; and delivering a confirmation of purchase based on the payment information to the universal electronic transaction device via a Bluetooth link paired as a result of the near-filed communication payment information exchange. During the near-field communication information exchange may comprise, exchanging keys for securing information exchanged via the Bluetooth link. This method may further include exchanging a user authorization for the purchase via the Bluetooth link. The user authorization may include at least one of an electronic signature and a digital representation of a user's signature. The digital representation of the user's signature is captured through a signature input facility of the universal electronic transaction device. This method may further include delivering offers to the universal electronic transaction device via a Bluetooth link paired as a result of the near-filed communication payment information exchange.

Methods and systems of a multi-network transaction platform may include a method of commerce may include: exchanging pairing information to facilitate Bluetooth communication between a universal electronic transaction device and at least one other Bluetooth-enabled device via an NFC tap of the universal electronic transaction device with an NFC terminal; establishing a Bluetooth link between the universal electronic transaction device and the at least one other Bluetooth-enabled device; and conducting electronic commerce via the Bluetooth link. This method may further include delivering a confirmation of purchase based on the payment information to the universal electronic transaction device via the Bluetooth link. In addition, during the near-field communication information exchange, keys for securing information exchanged via the Bluetooth link may be exchanged. This method may further include exchanging a user authorization for the purchase via the Bluetooth link. The user authorization may include at least one of an electronic signature and a digital representation of a user's signature. The digital representation of the user's signature is captured through a signature input facility of the universal electronic transaction device. This method may further include delivering offers to the universal electronic transaction device via a Bluetooth link paired as a result of the near-filed communication payment information exchange. This method may further include receiving a commitment to purchase an item identified by the NFC terminal via the NFC tap. Conducting electronic commerce may include requesting payment for the item identified in the commitment and receiving method of payment information from the universal electronic transaction device.

Methods and systems of a multi-network transaction platform may include a method of commerce may include: receiving information consistent with a request for wireless authentication from a universal electronic transaction device during a near-field communication payment information exchange; during the near-field communication information exchange, delivering wireless network authentication information to the universal electronic transaction device to facilitate authenticated access to the wireless network of the universal electronic transaction device; and delivering a confirmation of purchase based on the payment information to the universal electronic transaction device via the wireless network as a result of the near-filed communication payment information exchange. During the near-field communication information exchange may comprise, exchanging keys for securing information exchanged via the wireless network. This method may further include exchanging a user authorization for the purchase via the wireless network. The user authorization may include at least one of an electronic signature and a digital representation of a user's signature. The digital representation of the user's signature may be captured through a signature input facility of the universal electronic transaction device. This method may further include delivering offers to the universal electronic transaction device via a wireless network access to which is authenticated as a result of the near-filed communication payment information exchange

Methods and systems of a multi-network transaction platform may include a method of commerce may include: exchanging wireless network authentication information to facilitate communication between a universal electronic transaction device and at least one other wireless network-enabled device via an short-range information exchange between the universal electronic transaction device and a point of sale transaction terminal; establishing a wireless link via the wireless network between the universal electronic transaction device and the at least one other wireless network-enabled device; and conducting electronic commerce via the wireless link. This method may further include delivering a confirmation of purchase based on the payment information to the universal electronic transaction device via the wireless link. During the short-range communication information exchange, exchanging keys for securing information exchanged via the wireless network link. This method may further include exchanging a user authorization for the purchase via the wireless link. The user authorization may include at least one of an electronic signature and a digital representation of a user's signature. The digital representation of the user's signature may be captured through a signature input facility of the universal electronic transaction device. This method may further include delivering offers to the universal electronic transaction device via a wireless network that is authenticated as a result of the short-range communication payment information exchange. This method may further include receiving a commitment to purchase an item identified by the short-range terminal via the short-range information exchange. Conducting electronic commerce may include requesting payment for the item identified in the commitment and receiving method of payment information from the universal electronic transaction device.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 depicts an example of a retail environment in which an NFC tap for a Bluetooth pairing may be used to facilitate mobile transaction processing;

FIG. 2 depicts an example of an NFC tap-to-pay and pair method to facilitate a Bluetooth receipt process;

FIG. 3 depicts an example of an NFC tap and pair with optional purchase commitment method to facilitate a Bluetooth mobile transaction process

FIG. 4 depicts an example of a retail environment in which an NFC tap for WiFi authentication may be used to facilitate mobile transaction processing;

FIG. 5 depicts an example of an NFC tap-to-pay and Wi-Fi authentication method to facilitate a WiFi receipt process;

FIG. 6 illustrates a use case scenario at a Restaurant;

FIG. 7 illustrates a use case scenario at a Hotel;

FIG. 8 illustrates exchanging network information during an NFC tap to facilitate mobile transaction processing over a secure wireless network;

FIG. 9 depicts elements of a mobile transaction platform for secure personalized transactions in combination with multi-network authentication and service;

FIG. 10 depicts a multi-network transaction flow from a service provider perspective; and

FIG. 11 depicts a multi-network transaction flow from a mobile wallet perspective.

### DETAILED DESCRIPTION OF THE PREFERRED EMBODIMENT(S)

The methods and systems described herein may include use of a multi-tier platform for personalized secure transactions in an ecosystem of participants including users, mobile devices, merchants, service providers, instrument issuers, transaction acquirers, and the like. The methods and systems described herein may further interface with transaction service elements such as wallets, widgets, containers, applets, tiers such as personalization, enabling, and service tiers, and other features and capabilities that facilitate secure personalized transactions among participants of the ecosystem. The methods and systems of multi-network transaction processing and other transaction processing in a retail environment described herein may benefit from and/or utilize the features, functions, capabilities, and the like that are depicted in the figures and described in co-owned U.S. Ser. No 13/909,262 the entirety of which is incorporated herein by reference.

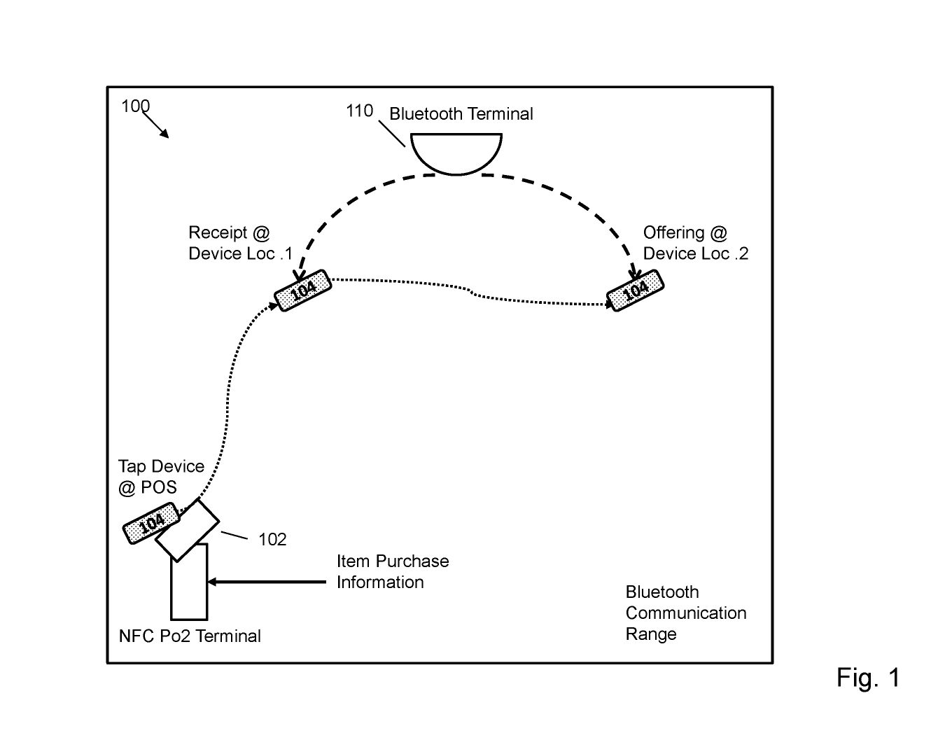

FIG. 1 illustrates generally, but not by the way of limitation, an example of a retail environment 100 in which an NFC tap for Bluetooth pairing may be used. The retail environment 100 may enable an NFC POS terminal 102, a wireless communication device 104, and a Bluetooth terminal 110 to coordinate for electronic commerce, in accordance with an embodiment of the invention. The NFC POS terminal 102 may provide a means to transfer transaction and payment-related information from the wireless communication device 104 to the Bluetooth terminal 110 and to a backend transaction processing system in a communication network. The wireless communication device 104 described herein may include for example, but not limited to, Personal Digital Assistant (PDA), Tablet Personal Computer (Tablet PC), cellular telephones, smart phones, universal electronic transaction device, handheld mobile device, and the like.

The NFC POS terminal 102 may enable the wireless communication device 104 to use Bluetooth technology such as for electronic transactions with a single tap-and-go payment and receipt capabilities. The NFC POS terminal 102 may allow the wireless communication device 104 to quickly transfer the payment-related information via NFC, Bluetooth, and the like.

The Bluetooth terminal 110 described herein may enable the wireless communication device 104 to wirelessly communicate in the retail environment 100 to facilitate a wide range of touch point opportunities associated with a purchase or electronic transaction. As a consumer moves about the retail environment 100 with a paired wireless communication device 104, the user may be notified of offers, purchase opportunities, confirmation of prior NFC purchases, confirmation of Bluetooth purchases, and the like without being required to be within NFC range of an NFC terminal such as NFC POS terminal 102. While the NFC POS terminal 102 may support wireless communication within four centimeters of the wireless communication device 104, the Bluetooth terminal 110 may enhance the range of wireless communication to 10 meters or even more, which may allow the wireless communication device 104 user (e.g. a consumer) to move or walk while performing electronic transactions, and the like in the retail environment.

The touch point opportunities associated with a purchase or electronic transaction may include for example, but not limited to, receipt, couponing, recommended items (e.g., batteries for an item that requires batteries), deluxe memberships based on the transaction history, discount, offer, gift, and the like. In addition to sending coupons and the like as touch point messages, Bluetooth may further facilitate wireless transfer of diverse formatted content to/from a wireless communication device 104. The content provided over the Bluetooth terminal 110 may include, for example, but not limited to, a URL, a video, an audio message, a receipt or acknowledgement message, transaction data, and the like. In an example, a purchase for a cosmetic product may be conducted over the NFC/Bluetooth system described herein and a short video of application of the cosmetic may be delivered to the wireless communication device 104 after the purchase.

As a result of a conventional NFC-style “tap” of the wireless communication device 104 with the NFC POS terminal 102, the terminal 102 may perform a pairing handshake with the device 104 and set up the Bluetooth pairing between the wireless communication device 104 and any other Bluetooth-enabled device, such as a device in the retail environment including the NFC POS terminal 102, the Bluetooth terminal 110, and the like. The NFC POS terminal 102 may use the NFC protocols as a medium such as for exchange of device-to-device information to facilitate Bluetooth pairing via the Bluetooth terminal 110. In this way, traditional NFC POS terminal 102 tap-to-pay may be combined with Bluetooth pairing for fast electronic payment information transfer to the NFC POS terminal 102 and later delivery of payment confirmation (e.g. a payment receipt) via Bluetooth. In addition to exchange of device-to-device information for Bluetooth pairing, additional information, including security key information for securing data transferred over a Bluetooth link may be exchanged (e.g. encryption keys and/or signing keys). The information received by the NFC POS terminal 102 from the device 104 may be processed by the terminal 102 and/or may be forwarded to a central server, one or more of the Bluetooth terminals 110, to another NFC POS terminal, and the like for processing including handling of device paring, security key exchange and configuration, and the like.

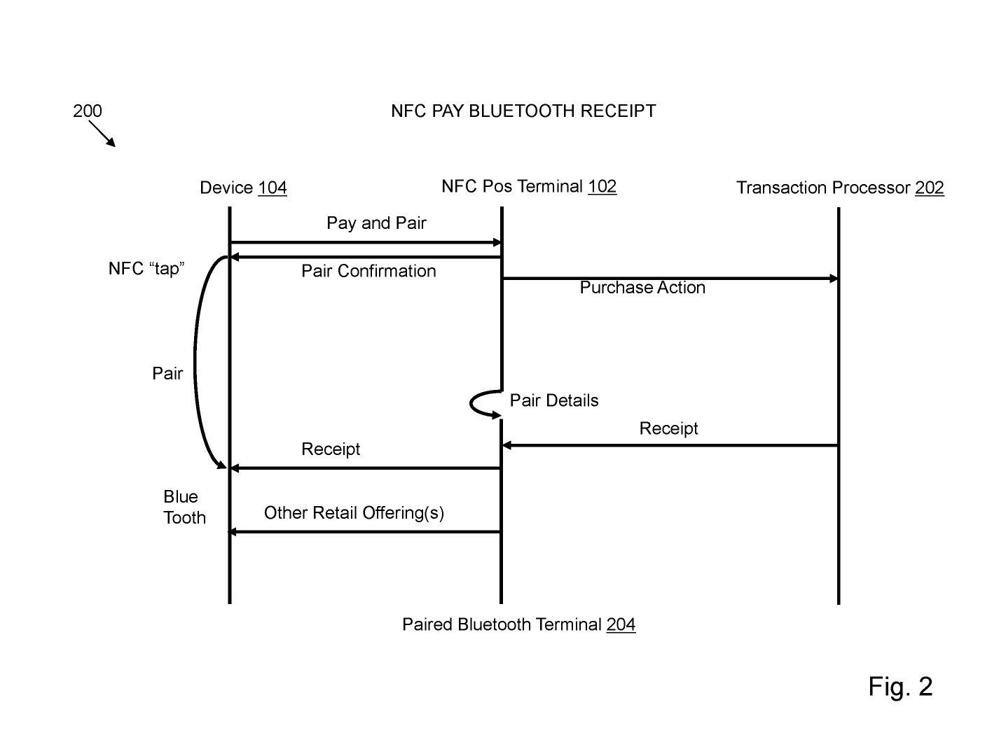

FIG. 2 illustrates generally, but not by the way of limitation, an example of an NFC tap-to-pay and Bluetooth pair method 200 that includes a follow-on Bluetooth receipt process, in accordance with various embodiments of the present invention. The wireless communication device 104 may send a payment request to pay to the NFC POS terminal 102. The NFC POS terminal 102 may automatically perform a handshake and set up the Bluetooth pairing with the wireless communication device 104 so that wireless communication device 104 may connect with any Bluetooth terminal associated with a retail environment (e.g. Bluetooth terminal 110). Upon receipt of the request to pay from the wireless device 104, the NFC POS terminal 102 may send a request indicating a purchase action to be performed by a transaction processor 202. The transaction processor 202 described herein may be for example, a universal electronic transaction facility, transaction server, service provider, and the like as described herein. The NFC POS terminal 102 may transfer Bluetooth pairing and/or other details to a Paired Bluetooth terminal 204, which may be similar to the Bluetooth terminal 110 described herein. The transaction processor 202 may perform the electronic purchase transaction, in accordance with the request received from the NFC POS terminal 102, and may send a receipt to one or more devices in the retail environment that may further communicate the receipt to the wireless device 104. Such devices may include the NFC terminal 102, the Bluetooth terminal 110, the paired Bluetooth terminal 204, and the like. The receipt may be for acknowledging the electronic transaction performed by the transaction processor 202. A paired Bluetooth terminal 204 may send the receipt to the wireless communication device 104, thereby acknowledging the electronic transaction performed by the transaction processor 202. The wireless communication device 104 may also receive offers related to the user purchased item or history or the like from a Bluetooth device that may have been paired during the NFC purchase information transfer described above.

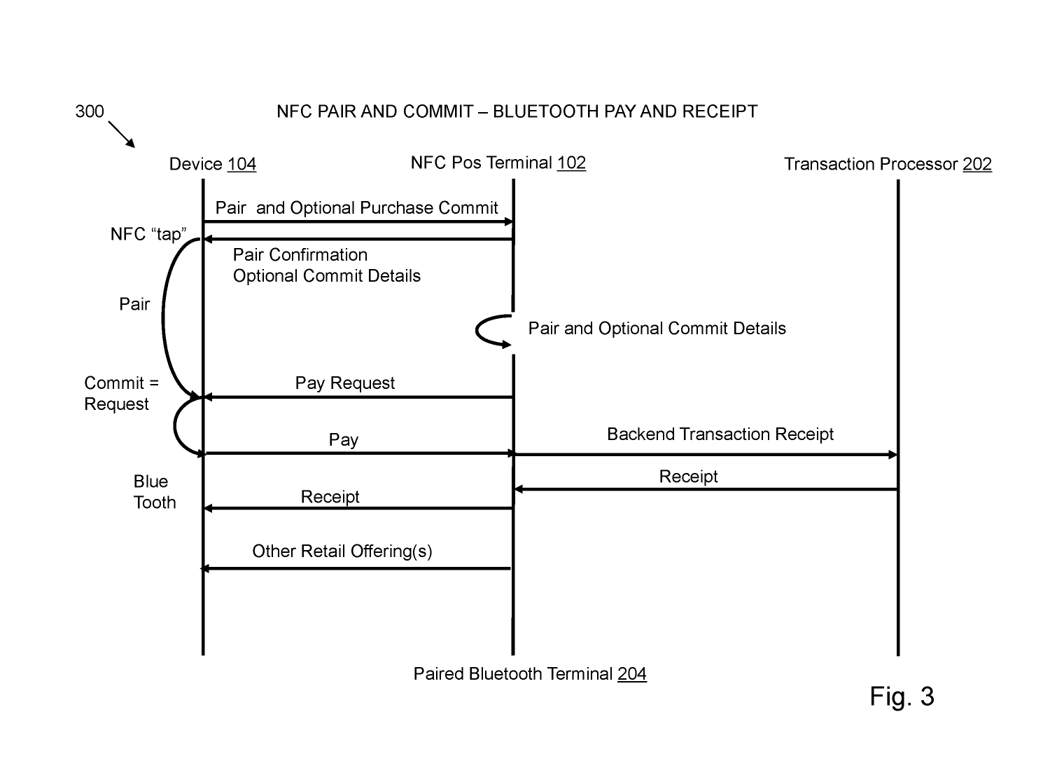

FIG. 3 illustrates generally, but not by the way of limitation, an example of an NFC tap and Bluetooth pair with optional purchase commit method 300 followed by the Bluetooth purchase transaction processes, in accordance with various embodiments of the present invention. The method 300 may allow the wireless communication device 104 to send a request (optionally including a commit or request to purchase an item) and optionally a request for Bluetooth pairing. The NFC POS terminal 102 may automatically perform a handshake and set up the Bluetooth pairing with the wireless communication device 104 as described herein. The NFC POS terminal 102 may send a paired confirmation and the optional purchase commits detail to the wireless communication device 104 for later use. The NFC POS may transfer the optional device pair and purchase commits request information so that it is accessible by Bluetooth devices, such as paired Bluetooth terminal 204. As the user moves around the retail environment, the paired Bluetooth terminal 204 may send a payment request to the wireless communication device 104. In the case of the optional purchase commit information being exchanged between the NFC POS terminal 102 and the device 104 during the “tap”, the device 104 may validate the payment request and based on the validation may send a request for clearing or processing the payment via Bluetooth that may indicate a purchase action to be performed by the transaction processor 202. The transaction processor 202 may perform the electronic purchase transaction and may send a receipt that may be delivered to the device 104 via Bluetooth. The receipt may be for acknowledging the electronic transaction performed by the transaction processor 202. The wireless communication device 104 may also receive the offers related to the user purchase item or history or the like over the paired Bluetooth communication link(s).

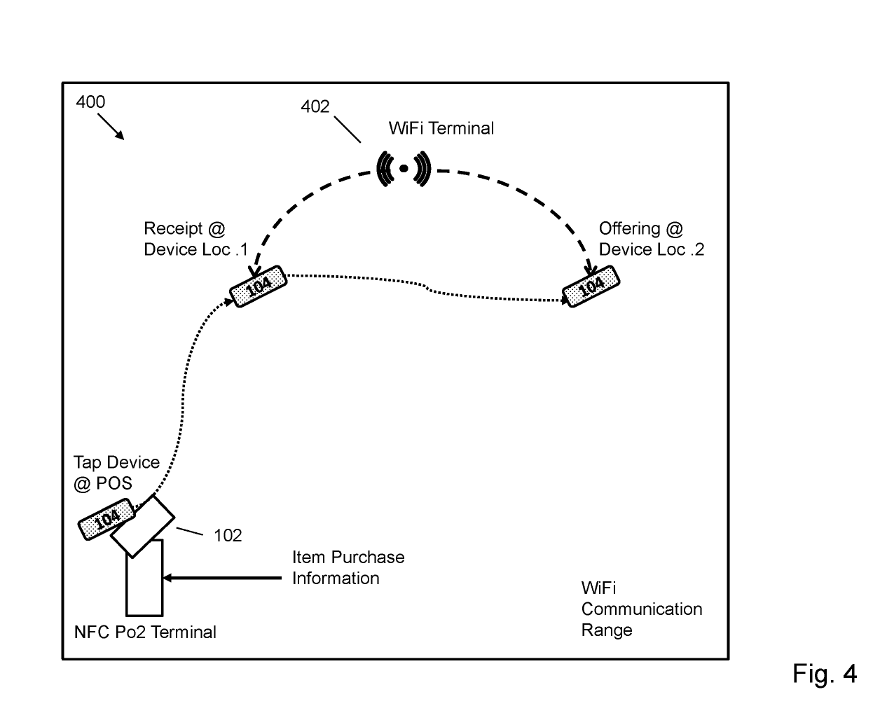

FIG. 4 illustrates generally, but not by the way of limitation, an example of a retail environment 100 in which an NFC-based transaction facilitates authentication of a mobile device to conduct mobile transactions over a local wireless network, such as through a WiFi terminal 402. The retail environment 100 may enable an NFC POS terminal 102, a wireless communication device 104, and a WiFi terminal 402 to coordinate for electronic commerce, in accordance with an embodiment of the invention. The NFC POS terminal 102 may provide a means to transfer at least a portion of transaction, device, user, network, security, and payment-related information from the wireless communication device 104 via the WiFi terminal 402 to a backend transaction processing system in a communication network. The NFC POS terminal 102 may enable the wireless communication device 104 to use the WiFi technology such as for electronic transactions with a single tap-and-go payment and receipt capabilities. The NFC POS terminal 102 may allow the wireless communication device 104 to quickly transfer the payment-related information via NFC, Bluetooth, WiFi, and the like.

The WiFi terminal 402 described herein may enable the wireless communication device 104 to wirelessly communicate in the retail environment 100 such as to facilitate a wide range of touch point opportunities associated with a purchase, an offer, or any other electronic information exchange, including mobile transactions. In an example, as a consumer moves about the retail environment 100 with a wireless communication device 104 that has been enabled to be authenticated on a wireless network via the NFC tap interaction, the consumer (e.g. mobile device user) may be notified of offers, purchase opportunities, confirmation of prior purchases (e.g. NFC purchases), confirmation of returns, and the like without being required to be within NFC range of an NFC terminal such as NFC POS terminal 102. While the NFC POS terminal 102 may support wireless communication within four centimeters of the wireless communication device 104, the WiFi terminal 402 may enhance the range of wireless communication, which may allow the wireless communication device 104 user (e.g. a consumer) to move or walk about and in proximity to the retail environment 100 while performing electronic transactions, and the like as described herein.

In an aspect, in addition to sending coupons and the like as touch point messages, wireless network authentication as described herein (e.g. via a NFC tap interaction) may further facilitate wireless transfer of diverse formatted content to/from the wireless communication device 104. The content provided over the WiFi terminal 402 may include, for example, but not limited to, a URL, a video, an audio message, a receipt or acknowledgement message, transaction data, store information, comparative shopping information, discounts, and the like. In an example, a purchase for a cosmetic product may be conducted over the NFC system described herein and a short video of application of the cosmetic may be delivered to the wireless communication device 104 after the purchase.

As a result of a conventional NFC-style “tap” of the wireless communication device 104 with the NFC POS terminal 102, the terminal 102 may perform a ID exchange handshake with the device 104 that may include receiving device ID and optionally user ID information from the device 104 and optionally providing wireless network ID and/or authentication token information to the device 104. The Terminal 102 may also send the wireless communication device 104 device ID and/or user ID information to the WiFi terminal 402. The information of the wireless communication device sent to the WiFi terminal 402 may include the device credential information such as the WiFi user name and password, and other device related authentication information as described herein. In an example, the NFC POS terminal 102 may send the device credential information to the Wi-Fi terminal as well as purchase transaction information to a transaction processor. In an example, Wi-Fi network access may require a NFC tap handshake (e.g. to receive a current authentication token) even for devices that had previously used the Wi-Fi network (e.g. known devices) so that merely passing through the WiFi network does not necessarily enable conducting mobile transactions over the network. In another example, the WiFi network may automatically identify and authenticate previously authenticated/known devices without requiring an NFC tap handshake.

In an example conducting mobile transactions over a Wi-Fi or other local network based on NFC tap authentication, the WiFi terminal 402 may be configured to use the device/user credentials to authenticate the device to perform an electronic transaction. The NFC POS terminal 102 may use P-P (peer-to-peer) protocols to exchange network and device information during the NFC transaction. Other NFC protocols that support two-way data exchange may also be used. In this way, tap-to-pay using current technology NFC POS terminals may be combined with wireless network technology for fast electronic payment information transfer through the NFC POS terminal 102 with latent delivery of payment confirmation (e.g. a payment receipt) via the WiFi network. In addition to exchange of network and device information for authentication, additional information, including security key information for securing data transferred over the WiFi network may be exchanged (e.g. encryption keys and/or signing keys). The information received by the NFC POS terminal 102 from the device 104 may be processed by the terminal 102 and/or may be forwarded to a central server, one or more of the WiFi terminals 402, to another NFC POS terminal, and the like for processing including handling of device identification, authenticating, security key exchange and configuration, and the like.

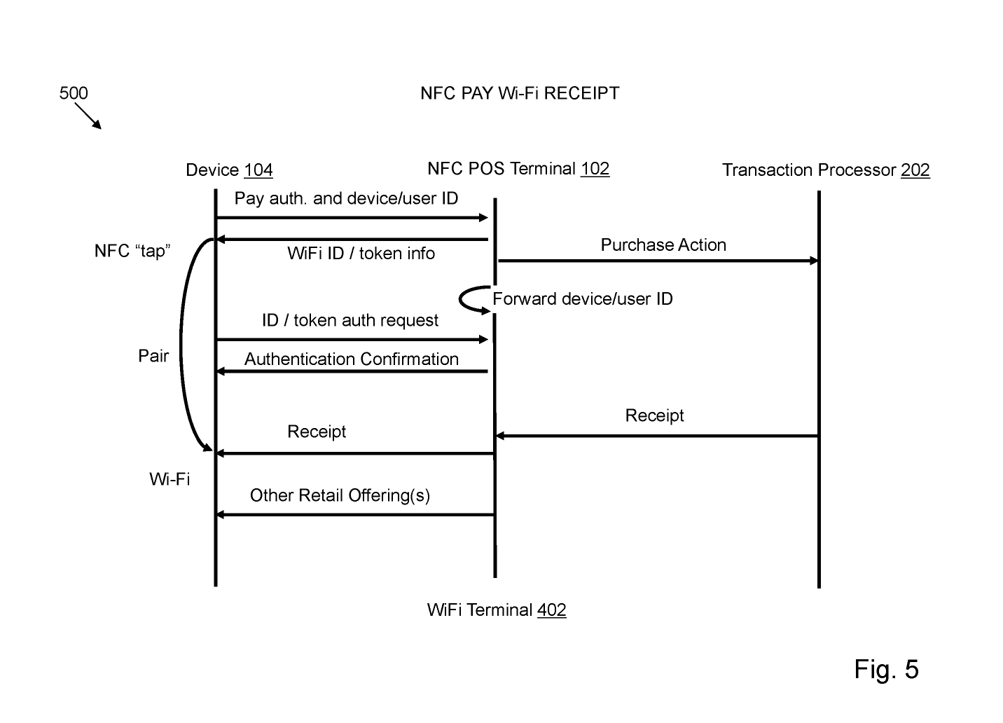

FIG. 5 depicts an example of an NFC tap-to-pay and Wi-Fi authentication method to facilitate a Wi-Fi receipt process. The wireless communication device 104 may send a payment request to pay to the NFC POS terminal 102. The NFC POS terminal 102 may automatically perform the ID exchange handshake as described for the embodiment of FIG. 4 so that the wireless communication device 104 may connect with any WiFi terminal (e.g. WiFi terminal 402) associated with a wireless network of the retail environment.

During a NFC “tap” information exchange between the device 104 and the terminal 102, the terminal 102 may receive an authorization to pay along with device/user identification data. In return, the device 104 may receive wireless network information such as the network SSID, a secure token for authentication on the wireless network, and the like. Upon receipt of the request to pay from the wireless device 104, the NFC POS terminal 102 may send a request indicating a purchase action to the transaction processor 202. The NFC POS terminal 102 may transfer the device/user ID information to the WiFi terminal 402. The information sent to the WiFi terminal 204 may include the device credential information such as the user name and the password. The information may be sent via the wireless network if the NFC POS terminal 102 supports communication over a wireless network, such as Wi-Fi. The WiFi terminal 402 may use the device information to identify the device user and authenticate the wireless communication device 104. In an aspect, in addition to exchange of device and network ID information for device authentication during the NFC tap event, additional information, such as security key information for securing all sorts of data that may be transferred over the WiFi network may be sent to the device 104 (e.g. encryption keys and/or signing keys). The information received by the NFC POS terminal 102 from the device 104 may be processed by the WiFi terminal 402 and/or may be forwarded to a central server, one or more of the WiFi terminals 402, to another NFC POS terminal, and the like for processing including handling of device or user authenticating, security key exchange and configuration, and the like.

After completing the NFC tap information exchange, the device 104 may communicate with the Wi-Fi terminal 402 to complete authentication and enable the wireless device 104 to use the wireless network. This may use any known or contemplated authentication scheme including having the device 104 send the token that it received from the NFC terminal 102 to the wireless terminal 402. If the device 104 can be quickly identified by the POS computer during the NFC tap action. The NFC terminal may provide an authentication token that can be used by the wireless communication device 104 during transactions over the wireless network. Alternatively, as described above, the WiFi terminal 402 may send an authentication confirmation message to the wireless communication device 104 that was identified at the NFC tap event. The transaction processor 202, in communication with the WiFi terminal 402, may perform the electronic purchase transaction, in accordance with the request received from the NFC POS terminal 102, and may send a receipt to one or more devices in the retail environment that may further communicate the receipt to the wireless device 104. The receipt may be for acknowledging the electronic transaction performed by the transaction processor 202 for the purchase of items identified by the device 104 in the original NFC tap action. The wireless communication device 104 may also receive offers such as offers related to the user purchase history or the like over the WiFi network.

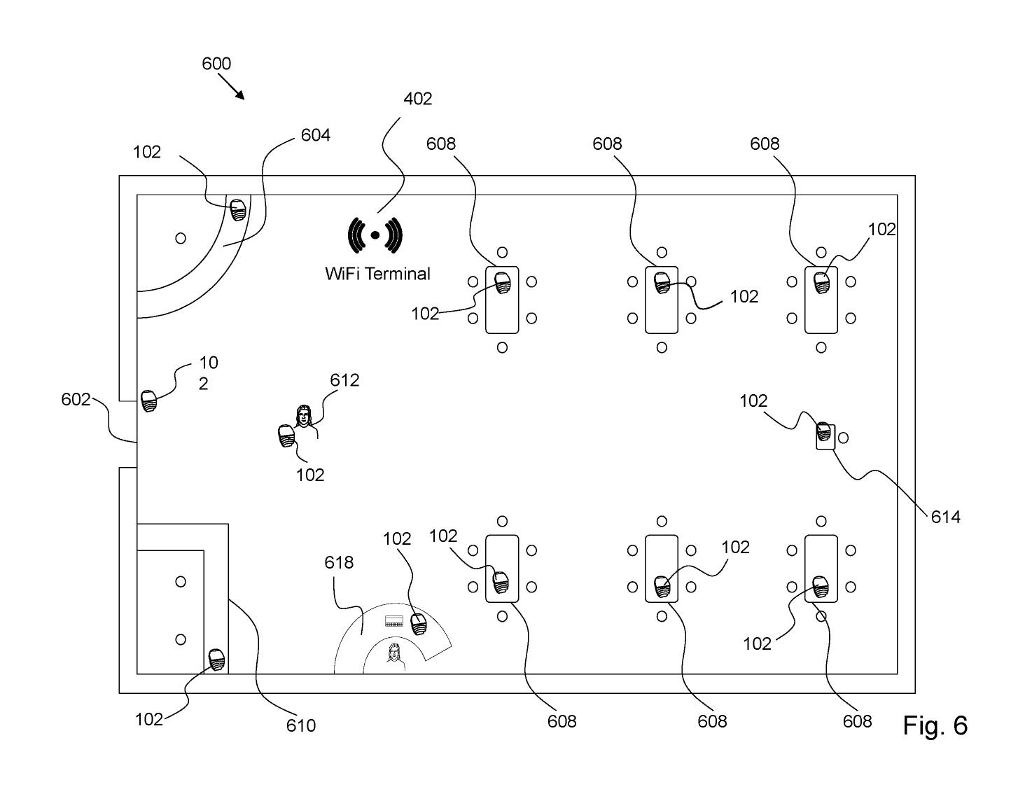

FIG. 6 illustrates a use case scenario at a Restaurant 600 in which the NFC tap to pair (for Bluetooth) or to authenticate (for a wireless network) and the like may be used to enable a wide range of mobile transaction processing associated with a visit to a restaurant, including but not limited to authorizing paying the meal bill through an electronic payment transaction. A restaurant use scenario may involve similar pairing and/or network authentication techniques described herein including, without limitation exchange of network and device information for authentication including security key information for securing data transferred over a WiFi network (e.g. encryption keys and/or signing keys). The restaurant environment may leverage the low cost and ease of use of a multi-function NFC-tap as described herein by deploying a variety of NFC terminals throughout the restaurant. In this way the NFC terminal 102 may not be just a payment terminal at a checkout or cashier station, but may be embodied as other devices. Some examples include deploying an NFC terminal 102 at a store entrance, at a kiosk, at a display, at a ‘welcome’ station, a mobile device operated by a store employee (e.g. a hostess), a stall, a booth, an eating table, a waiting area, pavilion, a newsstand, a stand, and the like. The NFC terminal 102 may be placed at an entrance 602, at a hostess desk 604 (e.g. when giving your name to the hostess to wait for a table), at a table 608, at the bar 610, a waiter/waitress device 612, at a seat yourself sign 614, a hostess device 618, and the like. One or more wireless terminals may also be located in the restaurant environment so that the device 104 may access the restaurant wireless network as a result of a successful NFC tap information exchange as described herein. This may result in a user's device 104 being the gateway for all electronic information associated with the user's visit to the restaurant. By being able to access the user's device 104 over a restaurant-specific wireless network, the device may receive menu information, item nutrition information, wait staff names and faces, offers, suggestions for wine, and the like. The user's device 104 may become a portal into the a wide range of restaurant-related information (e.g. number of patrons ordering a specific entry, reservation options, ID check for ordering alcoholic beverages, and the like including paying the meal bill. The wireless terminal 402 may send the bill to the user device 104. The bill may be presented to the user on the device 104. In an aspect, the bill described herein may be a paper bill. The user may perform the activities such as view the bill, approve the totals, determine payment type, send a payment request, and the like.

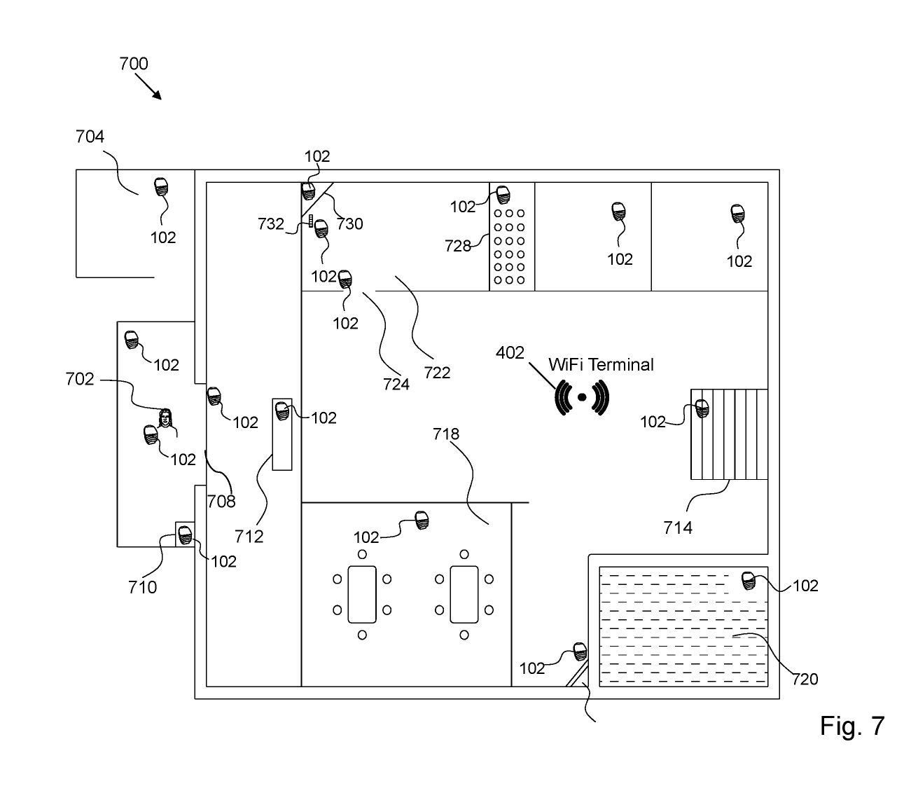

FIG. 7 illustrates a use case scenario at a Hotel 700 that may gain the benefits of the NFC tap and pair or authenticate functionality described herein along with the distributed NFC terminal concepts described in regards to the restaurant embodiment of FIG. 6. A hotel use scenario may involve similar pairing and/or network authentication techniques described herein including, without limitation exchange of network and device information for authentication including security key information for securing data transferred over a WiFi network (e.g. encryption keys and/or signing keys). The NFC terminal in the hotel embodiment may be placed at valet 702, a self park 704, a entrance 708, a concierge 710, a front desk (checking) 712, an elevator 714, a restaurant/breakfast buffet 718, the pool 720, a guest room 722, entry 724, minibar 728, television 730, television remote control 732, and the like. A simple NFC tap at any of these terminals may enable the device 104 to use the Hotel's wireless network 402 for mobile transaction processing. Similarly to the restaurant embodiment of FIG. 6, the users' wireless device 104 may become the main portal or gateway through with the user communicates with the hotel systems and performs mobile transactions during his/her stay.

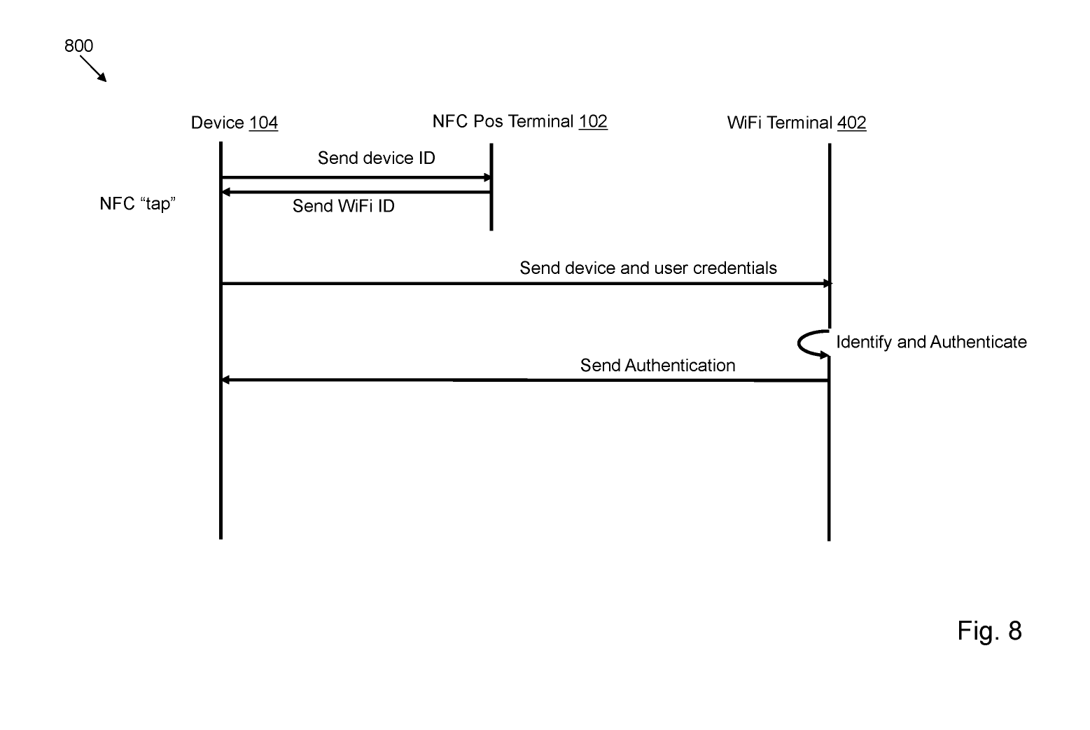

FIG. 8 illustrates exchanging network information during an NFC tap to facilitate mobile transaction processing over a secure wireless network. The exchange of network information begins with a wireless communication device 104 being brought into near-field communication range of a terminal so as to allow the terminal to detect the device. The device may also actively detect the NFC terminal. Upon detection the terminal and the device may exchange information to facilitate enabling the wireless device to access a private wireless network associated with the terminal. The device may send a set of data that may include device identification, user identification, account identification, and the like to the NFC terminal. The NFC POS terminal 102 may receive the device information and may send information about the private wireless network to inform the device about the network so that the device can request access to the wireless network. In the embodiment of FIG. 8, the NFC terminal provides identification (e.g. SSID) information about the wireless network to the device. Subsequent to this NFC exchange of information, the device may attempt to access the wireless network, such as by sending device and user identification credentials for authentication on the wireless network. In the embodiment of FIG. 8, a Wi-Fi terminal 402 represents some wireless network resources, such as a router, bridge, hot spot, server, network appliance, and the like. The WiFi terminal 402 may uses the device and/or user information to identify and authenticate the user and the wireless communication device 104. The wireless network resource (e.g. Wi-Fi terminal 402) may send an authorization or activation signal to the wireless device 104 to enable mobile transactions between the device 104 and resources on and available through the wireless network 402.

The user authorization for access to the wireless network may be based on at least one of an electronic signature and a digital representation of a manual signature. In an aspect, the digital representation of the manual signature may be captured through a signature input facility, such as a touch screen or signature pad of the wireless device 104. In another example, the user may manually sign a document, such as an invoice, a check, or the like at the time of conducting a transaction and the user may capture his/her signature with a camera feature of the wireless device 104. Alternatively, the user may carry a signature card or may have a digitized version of his/her signature that can be displayed on a screen so that the camera feature may capture his/her signature for the purposes of authenticating the user of the wireless device 104.

Near Field Communication technologies and protocols that are known, contemplated, or otherwise support exchange of information between a wireless device and a terminal during an NFC tap action may be supported by the wireless device 104. Standards such as ISO/IEC 18092/ECMA-340 ; ISO/IEC 21481/ECMA-352; ISO/IEC 14443 Type A and Type B, FeliCa and the like may be used in the NFC tap action. The methods and systems of NFC tap to enable pairing for Bluetooth or to enable wireless network authentication may use a bi-directional capability that may be described as a p-p.

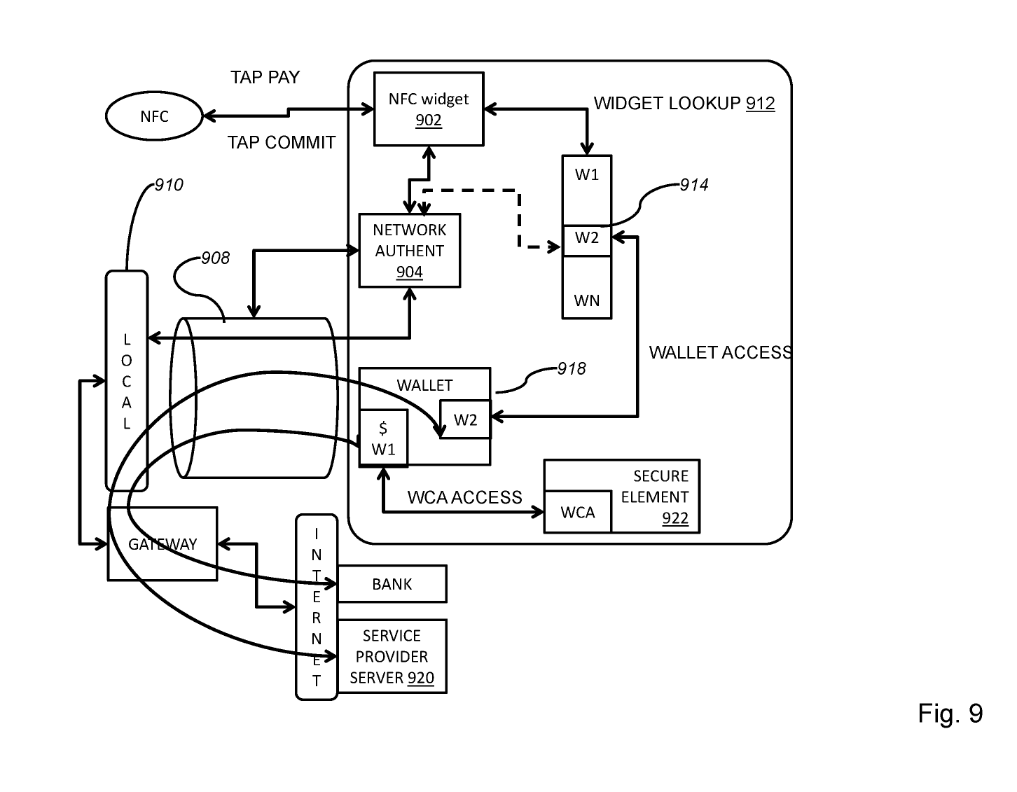

FIG. 9 depicts elements of a multi-tier mobile transaction platform for secure personalized transactions that may facilitate execution of the multi-network transaction methods and systems described herein. Mobile-device localized elements may include an NFC widget 902 that is capable of processing data received via an NFC-style tap operation as described herein. The NFC widget 902 may interact with network authentication functionality 904 that may configure an local wireless access interface 908 to a local network 910. The NFC widget 904 may also facilitate selection of a widget via a widget lookup feature 912 of the mobile device. The NFC widget 910 may provide information, such as a network SSID, vendor identifier, or the like that may facilitate identification of a widget, such as a service provider-specific widget. The lookup function 912 may also interact with the network authentication capability 904 so that an identified widget is activated in coordination with authenticated access to the local network 910. An identified widget 914 may function to access a mobile wallet capability, such as a service-provider specific wallet 918 or wallet capability to exchange information over the local network 910 with a service provider 920. Secure capabilities of such a wallet may be accessed via widget that may be accessible in a secure storage (e.g. a mobile device secure element) 922.

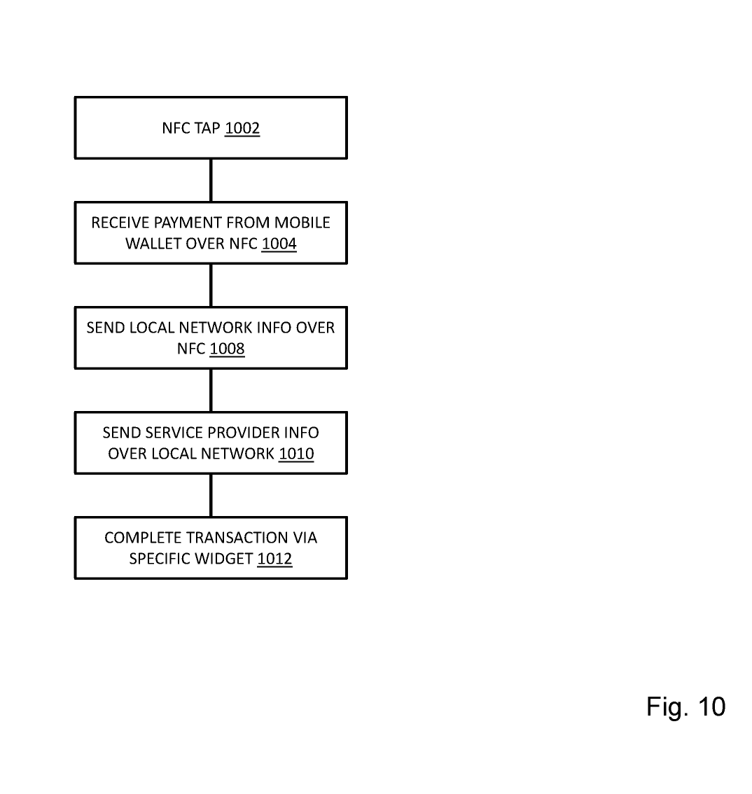

FIG. 10 depicts a multi-network transaction flow from a service provider perspective. A first network of the multi-network transaction flow may be an NFC network that may be activated by a NFC tap operation 1002. Payment information for a transaction may be received from a mobile wallet of the mobile device via NFC communication in step 1004. Local network access information may be sent to the mobile device over the NFC communication in step 1008. Service provider information, that may be used by the mobile device to access a service provider-specific widget, may be transmitted over the local network in step 1010. The transaction may be completed via the local network by exchanging information between the service provider and the service provider-specific widget in step 1012.

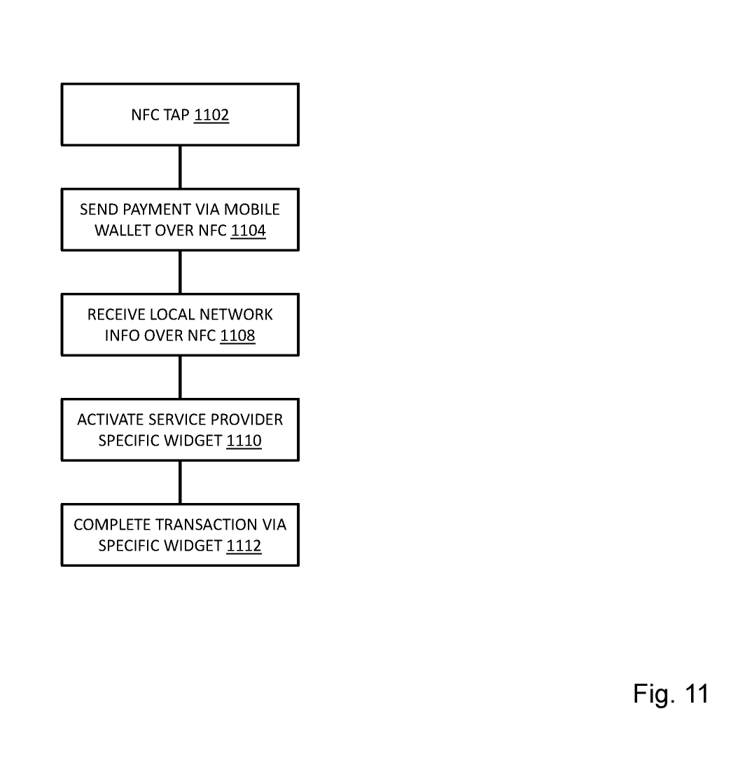

FIG. 11 depicts a multi-network transaction flow from a mobile device wallet/widget perspective. A first network of the multi-network transaction flow may be an NFC network that may be activated by a NFC tap operation 1102. Payment information for a transaction may be sent from a mobile wallet of the mobile device via NFC communication to a service provider in step 1104. Local network access information may be received by the mobile device over the NFC communication in step 1108. Service provider information that may be used by the mobile device to activate a service provider-specific widget may be derived from the local network access information in step 1110. The transaction may be completed via the local network by exchanging information between the service provider and the service provider-specific widget in step 1112.

In an embodiment, the Bluetooth/WiFi network may function similar to a merchant device, service provider facility, service provider system and the like, and may facilitate connection of the wireless device 104 with a transaction service provider. Alternatively, the Bluetooth/WiFi network may act as a communication gateway between a paired wireless device 104 and a service provider server for conducting purchase type transactions, and the like.

A multi-tier platform for secure personalized transactions may include a personalization tier for enabling such secure personalized transactions. The personalization tier may be configured to enable an ecosystem of participants, such as a service provider to personalize information, such as NFC information to enable use of service provider specific capabilities of a mobile device upon authentication onto a local wireless network of a mobile device. As noted herein, the personalization tier may be used to effect specific branding elements (such as trademarks, logos, themes, colors or the like), user interaction elements, workflows (such as stored account and transaction data to enable efficient completion of repeated transactions, shopping carts, single-click transactions and many others), user interface effects (such as transitions, content formats, dynamics or any other action), cause and/or effect that may be required by a service provider for a specific requirement. A personalization layer may also be configured to facilitate the deployment of a service provider's corporate design or interaction philosophy as well as giving room to consumers to adjust to their personal needs and preferences, including for the visually impaired, and the like. In an example, the personalization layer of the multi-tier secure transaction platform may be used by an NFC network provider to create a branded mobile application targeting a specific business vertical that can be executed with the use of the NFC terminal. The branded mobile application may be an mWallet application that may be configured for use in the retail/financial domain, a mHealth application for the healthcare vertical, or the like. The mobile application may provide a core set of services to a user, specific to a domain for which it may have been created. The wallet, through its wallet container application may also facilitate application lifecycle and security, standardized user experience, widget management responsibilities, and other functions, features, and operations associated with the wallet, the widget, the service provider domain, and the like.

In regards to an NFC-related embodiment, the mobile application may be a wallet-environment assuming a retail domain application. The personalized NFC information may include or be indicative of at least one service provider-specific widget to be executed on the mobile device upon authentication onto a local wireless network. For example, personalization of such NFC information transmitted from the NFC terminal to the mobile device may include identifiers and other details specific to a particular widget and also the corresponding service provider to which the widget is associated. The service provider information may be included in the form of a service provider identifier so that upon receipt of the NFC information, the mobile device identifies the widget and the corresponding service provider with the help of the mobile wallet application environment that may include wallets, wallet containers, widgets, applets, an enabling tier, and the like.

Widgets may be configured by a service provider to provide a wide range of transaction related functions. In a retail environment, a widget may enable a service provider to provide an ecosystem of business services that may be configured to authenticate a transaction. An exemplary authentication may be performed through exchange of NFC information between the mobile device and the NFC POS terminal directly. In another example, authentication may be effected by exchange of information that may be transmitted through another wireless network present in the retail environment other than an NFC network. This may be done by automatically connecting with another long range wireless network, such as WiFi, Bluetooth, and the like as describe herein. For example, the personalized NFC information delivered from the NFC terminal may facilitate pairing of the mobile device with a Bluetooth network terminal to enable transmission of relevant information over Bluetooth for authentication associated with personalized services of a service provider via a widget corresponding to the service provider. Alternatively, a WiFi or other wireless local area network may be substituted for a Bluetooth network. Payment for a purchase may be authenticated and a form of payment may be provided by communicating with the service provider-specific widget on the mobile device over the Bluetooth or WiFi network to a banking service provider, such as a web server configured as a participant in an ecosystem cloud. As described herein, the service provide-specific widget may reference an applet, such as an applet for accessing a secure element or other secure storage on the mobile device for implementing the personalized aspect of the transaction (e.g. a service provider security key or other security related data).

The multi-tier platform may be adapted to enable a service provider to ensure that NFC terminals within the local wireless network operating range, such as at merchant locations, are equipped to handle the personalized proximity protocols that may be used by the various wallets and widgets that may have been loaded into the mobile device. These NFC terminals may then process the transaction through an acquiring network that may switch the transaction to the appropriate ecosystem service provider in the cloud. The wallet and/or the widget may communicate with the ecosystem cloud over the local wireless network to determine service status and various other value-added service requirements like balance, transaction history, stored value top-up, and the like.

To further enhance security, the personalized NFC information may include a preferred and/or required wireless network for communicating between the service provider-specific widget and the service provider. This may result in the mobile device being redirected to the preferred wireless network to avoid transmitting security related or confidential information over a third-party network that may overlap the preferred wireless network range. Such an arrangement may be typically found in a retail environment where stores are in close proximity (e.g. a shopping mall).

As described herein, the personalization tier may comprise a software development kit for developing the service provider-specific widget. In this way, a service provider may build a service provider-specific widget for use in a retail multi-network environment using an SDK provided with the multi-tier platform.

As described in detail herein, the multi-tier platform for secure personalized transactions may also include a service tier. The service tier may be configured to enable service delivery from a service provider to a user of a mobile device via a local wireless network that may be accessed as a result of information that is provided to a mobile device during an NFC tap operation between the mobile device and a NFC terminal, such as in a retail environment. The service tier may cater to the specific requirements such as work flows, business logic, rules, intelligence, and needs of service verticals such as, but not limited to, retail transactions, banking, ticketing, bill payment, couponing, loyalty and point card programs, parking, and other ecosystem services. Services enabled by such a service tier may include mobile banking, money transfer, bill payments, ticketing, couponing, loyalty programs, marketing and advertising related services, education related services, city services, mobile health services, mobile insurance, transit services such as parking coupons, travel services, emergency or 911 services, retail payments, logistics support services, business intelligence solutions, branding, shopping, product authentication services, regulatory services, records management, interactive television services, text-to-voice services, location based services and the like. The services may be accessed using the multi-tier platform functionality operable on a mobile device.

In an example, the services may be accessed by the mobile device using an mWallet functionality of the mobile device over a WiFi network of a retail store. As described in more detail herein, the mobile device may be authenticated to use the local wireless network through the receipt of service provider and local wireless network information during an NFC tap operation between the mobile device and an NFC terminal that may be in an access range of the local wireless network. For example, the NFC terminal may send identifier details pertinent to the wireless network and the service provider to the mobile device during the NFC tap operation such that the identifiers may be indicative of the respective networks and the service provider associated with service delivery through the service tier. In an example, the information may also include widgets invitations and/or identifiers for the mobile device to authenticate downloading or updating of the widgets for secured and quick service delivery and interactions with the use of the service tier. Once the mobile device is authenticated to use the wireless network to communicate with the service provider, the service tier enables service delivery from the respective service provider to a user of a mobile device via wallets, wallet containers, widgets and other aspects of the multi-tier platform described herein.

A service tier as described herein may be configured to enable the mobile device to wirelessly communicate in a retail environment to access a wide range of touch point services associated with a purchase, an offer, or any other electronic information exchange, including mobile transactions. Through interactions between a service provider and multi-tier platform service elements, such as service elements (e.g. widgets) customized with the associated personalization tier, a user of a mobile device that has been enabled to be authenticated on a wireless network via an NFC tap interaction as described herein, may be notified of offers, purchase opportunities, confirmation of prior purchases (e.g. NFC purchases), confirmation of returns, and the like without being required to be within NFC range of an NFC terminal while still being in the retail environment.

In an example, the multi-tier platform for secure personalized transactions may further include an enabling tier. The enabling tier may be configured to operate on a mobile device to enable delivery of service provider and local wireless network information to a wallet container application executing on the mobile device. The enabling tier may facilitate access of mobile device feature and services, such as NFC communication services and features, WiFi configuration and communication services, Bluetooth pairing and communication services, and the like that may support the multi-network methods and systems described herein. An enabling tier, such as a runtime application environment operating on a mobile device, an mWallet capability may be able to communicate with an NFC terminal, redirect WiFi communication to a preferred/required wireless local area network, activate and communicate with a service provider-specific widget, and the like. An enabling tier may facilitate initiating a transaction over an NFC tap interaction and finishing that transaction over a preferred WiFi network by facilitating operation of the necessary service provider-specific widgets and providing an environment on the mobile device in which such widgets can maintain important information across such network switching.

The present document discloses methods of multi-network tokenization for electronic transaction security. The process of tokenization may facilitate securing content traversing multiple networks in a dynamic ecosystem for secure commerce and payment transactions. The methods may be related to multi-network purchase transactions that include an initial step of receiving a tokenized default form of payment information from a mobile wallet by an NFC terminal for performing an electronic transaction. The wallet may be service provider specific so that a specific form of payment may be tokenized and used for performing payment related transaction with a specific service provider. Further, certain widgets may be associated with a wallet that may allow facilitating payment in defined forms or modes including tokenization. For example, a widget A in association with a wallet W may be used to perform tokenization of payment related transaction with the service provider through retail coupons. In this case information about retail coupon codes may also be tokenized and transmitted from the mobile wallet to the NFC terminal. In another example, a widget B in association with a wallet X may be used to perform tokenized services related to another service provider through credit cards. In this case, the details about the credit card, such as credit card number, credit card holder's name, credit card's expiry date etc may also be tokenized to further secure the information and a resulting token may be transmitted from the wallet to the NFC terminal. Similarly any other information pertinent to the mode of payment may be tokenized and transferred from the wallet to the NFC terminal.

The tokenization process may be used to replace the information elements with a token. The token may be consistent of numeric characters, alphabetic characters, a combination of alphabetical and numeric characters, a truncated primary account number with alphabetic and numeric characters replacing the middle digits of the primary account number, and the like. The token may be a one-time use token. The token may be issued by a trusted entity in the dynamic ecosystem for secure commerce and payment transactions. The trusted entity may be a server located at the payment gateway, acquirer, or issuer or any other participant. The token may be generated as a mathematically reversible cryptographic function, a one-way non-reversible cryptographic function, or assigned through an index function, sequence number or a randomly generated number.

As exemplarily described above, the methods and systems described herein of ecosystem secure personalized transactions may include methods of tokenizing information in a secure personalized transaction. In an NFC/multi-network retail environment application, a token identifier of the tokenized representation and wireless local area network access/authentication information may be sent from to a mobile device from an NFC terminal during an NFC tap operation. The mobile device may receive the token identifier obtained from the tokenization process and information about the wireless network that is paired or connected with the NFC terminal for establishing communications over longer ranges. The information and the token identifier may be received by a wallet that is installed on the mobile device for further use by the widget, and other services of the mobile device and service elements of the multi-tier platform that are accessible on the mobile device, such as wallets, widgets, wallet containers, an enabling tier and the like. Tokenized multi-network transactions actions may further include forwarding the tokenization representation to a service provider for processing an electronic transaction. The service provider may then receive information from the mobile device over the wireless local area network that associates the tokenized representation with the mobile device. A tokenized confirmation that is identifiable by the token identifier may be forwarded from the service provider to the mobile device over the local area wireless network.

An NFC capable mobile wallet as described herein, may activate a service provider-specific set of widgets to provide service provider specific services. In an example, the NFC network may be used to perform an NFC tap operation between the NFC terminal and the mobile device. During an NFC interaction, information pertinent to a wireless network may be communicated to the mobile device by the NFC terminal. The information may also include specific details indicative of a service provider as well as the respective widgets of the service provider for delivery and interaction for specific services by/with the service provider. In response to receipt of at least the service provider and widget related information, the mobile wallet may activate the service provider-specific set of widgets. The widgets may be used to provide services over the wireless network identified through the NFC interaction. The specific wireless network identified in the NFC interaction may have been previously unknown to the wallet or the wallet capability.

As noted above, a wireless network may not have been known to a wallet capability; however over time, certain wireless networks will become known to the wallet capability. Accessing these wireless networks again may not require an NFC tap to access the wireless network information. In addition, as noted above, a service provider-specific widget may be activated when certain wireless networks are accessed to facilitate secure service delivery and transactions with a service provider. Therefore, to facilitate activation of service provider-specific widgets without requiring an NFC tap operation that identifies the widget, a wallet container application may operate cooperatively with the mobile wallet to update a table that cross references wireless network identification with service provider-specific widgets. For example, identifiers may be associated with each of the wireless networks and the service providers and the service provider-specific widgets. The identifiers may be updated in the reference table from where information may be derived about specific networks that are accessible in a retail environment and the associated service providers in the network and widgets specific to them. The cross referencing to the table may facilitate activating the service provider-specific set of widgets each time the specific wireless network is detected. For example, in a retail environment including a large number of stores of a specific service provider, each store may have a different WiFi network ID, yet a single service provider-specific widget may be used in all of the stores. In this manner, the single widget or widget set would be needed for all of the unique wireless networks. This association can be done by adding a wireless network identifier associated with a widget or a set of widgets into the table. The table may thus include references of the network identifiers and the service providers and the widgets specific to them so that after cross-referencing the table, and mapping wireless network identifier to a widget, the respective widget may be automatically activated as the mobile phone enters the same wireless network without needing any NFC tap interaction again and again. In this manner specific widgets may automatically get activated in specific network environments automatically. The reference table may thus facilitate an initialization engine for enabling automated widget activation and functioning without repeat NFC interactions.

The methods and systems of multi-network retail environment transaction processing may include a QR code decoding-capable mobile wallet and/or wallet container that may be configured to activate a service provider-specific set of widgets. The service provider-specific widgets may be configured to provide services to a user of the mobile device via the widgets over a wireless network in response to determining local wireless network identification information. The methods and systems relating to service provider-specific widgets and/or widget sets described above herein apply to these QR code related methods and systems. For example, the service provider-specific widgets may be configured to provide shopping related services in response to determining local wireless network identification information. The local wireless network identification information may include a network SSID, a secure token for authentication on the wireless network, and the like. This local wireless network identification information may be previously unknown to the wallet capability thereby enabling a mobile device that is configured with suitable multi-tier platform personalized service elements to conduct a transaction through personalized service elements, such as widgets through a preferred local wireless network of a retail environment. The local wireless network identification information may be obtained from a QR code that may be captured while the mobile wallet is in access range of the local wireless network, such as when a user of the mobile device uses the device to read a QR code on a kiosk in a retail store or other environment that includes a local area network.

In an example of a method for activating the service-provider specific set of widgets on a mobile device, the wireless network identification data for a service provider-specific network may be received by a wallet container application that provides a runtime environment for activating and executing widgets on the mobile device. The network identification data may be used to identify a service provider-specific widget for operation in the runtime environment, such as through a lookup function of the container that maps widgets to QR code information. The association of the network identification data and the service provider-specific widget may facilitate activation of the service provider-specific widget to communicate over the network with a specific service provider, such as the retail environment service provider. Once the service provider-specific widget is activated, the associated network identification data and a service provider-specific widget identifier for the service provider-specific widget may be stored in a network reference table in a memory of the mobile device as discussed above also. This network reference table may be referenced when a wireless network is detected by the mobile device to determine a service provider-specific widget to activate. In an example, the network identification data may include a network SSID that may be associated with a widget issued by a service provider. In such an instance, a widget issued by a service provider may be granted exclusive access to the workflow of the issuing service provider, resources on the mobile device, such as wallet resources, secure element resources, as well as to user interfaces of the client device. Likewise, a widget issued by a service provider that has been activated through the mobile wallet and/or wallet container may be denied access to the workflows, wallet elements, and the like of other service providers as well as to certain mobile device resources of the client device to ensure security of such service provider services and service elements. If the widget issued by the service provider is granted access to service provider data, the widget may be activated and may be launched within the runtime secure environment such as a wallet container operating on the mobile device.

As described above, a reference table of network identifiers and service provider-specific widgets may be built and maintained by the methods and systems described herein. Referencing the network reference table may be performed by a mobile wallet container or any other service element of the multi-tier platform for secure personalized transactions that may execute on the mobile device. The referenced information may facilitate activating a service provider-specific widget determined from matching a detected wireless network identifier (e.g. a broadcast SSID) to entries in the reference table. For example, the network reference table may include a plurality of network SSIDs so that each network SSID may correspond to a different wireless network. Each network SSID may be associated with a service provider-specific widget that should be activated to facilitate service delivery over that particular wireless network.

In an example, a service may be provided from a service provider to a user of a mobile device via a service provider-specific widget, over a private wireless local area network, after authenticating access to the private wireless local area network using network authentication credentials received through an NFC tap interaction and/or through ingestion of a QR or similar visual code. In an example, an NFC terminal associated with an enterprise may be located within the cafeteria of a multi-national (MNC) enterprise covered by a private wireless enterprise network. A user of a mobile device, such as an employee of the MNC may want to purchase an item at the cafeteria. The employee may select an item for purchase and make prefer to make a payment for an amount equivalent to the cost of the item through a netbanking service over netbank's private wireless network. The user may submit a request to use the netbanking service by tapping the mobile device at the NFC terminal.

Upon receipt of the request to pay with netbanking, the NFC terminal may send a network SSID information to the mobile device that may be used for authenticating the mobile device for accessing the cafeteria local area wireless network. Once the mobile device is authenticated, the NFC terminal may transfer information that uniquely identifies the mobile device to the bank's private network using the NFC wired network. The netbank may then attempt to access the mobile device over the MNC wireless network to confirm the purchase and/or deliver confirmation items, such as a receipt for the purchase to the mobile device. An appropriate wallet and/or widget on the mobile device may be operationally connected to this transaction so that when the netbank communicates to the mobile device over MNC's local area wireless network, a secure transaction channel may be configured between the wallet operating on the mobile device and netbank through the MNC local area network. Thereby providing a high degree of over the air security to complete the transaction.

In a variety of environments, QR codes may be used to provide information, such as a URL or similar information that can be used by a mobile phone to access information over any available network that facilitates access to the Internet. While some wireless networks offer security, such as through a network password and security capabilities (e.g. WEP, WPA, and the like), most networks merely act as a secure conduit for information exchange. In environments that are conducive to using a mobile phone to acquire a QR code, (e.g. a retail environment) it is possible to further customize a network environment so that services, such as personalized services, may be provided over the network in a secure and confidential manner. When a mobile device that is configured with service elements of a multi-tier platform for secure personalized transactions has access to capturing QR codes, it may be possible to activate certain personalized service elements of a mobile wallet subsystem on the mobile wallet through the QR code. In addition, a QR code may include information to facilitate directing the mobile device wireless interface to a preferred network that has inherent security, personalization, and is equipped to best facilitate service delivery from a service provider to a mobile device. A QR code may include network authentication credentials, such as a network SSID associated with the preferred wireless local area network, service provider information, service elements identity (e.g. a service provider-specific widget that is deployed on the phone), and the like that may facilitate high quality service delivery to a user of a mobile phone while in a retail or similar environment.

As noted above and herein, by providing information that aspects of the mobile wallet transaction environment that operate on the mobile device may use to identify and activate a specific installed widget, service delivery may be initiated as soon as the wireless network is accessed by the mobile device. In an example of personalized service information that may be delivered through a QR code, a preferred service provider widget identifier may be included in the QR code data set. Upon receipt of the preferred service provider widget identifier, a mobile wallet and/or a wallet container may use enabling tier capabilities described herein to access the widget. Upon access, the widget may be operated within a mobile container operating environment to enable exchange of information with a service provider who has developed the widget.

Mobile device action flow for such a method may include: receiving network and service provider information by capturing a QR code; configuring the mobile device to access the network identified in the QR code; activating a service provider-specific widget based on at least one of the service provider information and the network information; operating the service provider-specific widget to exchange information related to services that are available from a specific service provider, and the like. Transactions between the mobile device and the specific service provider may be performed via a newly activated service provider widget. In this way, for each different environment, a QR code may uniquely help activate a preferred wireless network and a service provider-specific widget.

Methods and systems of multi-network transaction processing may include a mobile wallet that may be used to perform an electronic transaction in a retail transaction environment. In an example, the retail transaction environment may include two distinct networks over which a single transaction may be performed. Further, the first wireless network may be used for sending second wireless network description information of the retail environment (e.g. an SSID, authentication code, service provider information, a transaction token, a personalization key, and the like) to the mobile device. The first wireless network may be a near-filed communication (NFC) network, while the second wireless network may be a Wi-Fi, Bluetooth, or similar local area wireless network.

Performing the transaction over the two distinct networks may include receiving default form of payment information from the mobile wallet over a first wireless network of the retail environment (e.g. an NFC network) with a mobile device on which the mobile wallet is deployed while the mobile device is in wireless network detection range of the second network. There are several possible multi-network transaction scenarios that may stem from this initial step. A few representative scenarios are now described. In all instances, second network information received by the mobile device during the NFC transaction is used by the mobile device to at least redirect its WiFi interface to the second wireless network. Also, in all exemplary scenarios, service elements of the mobile device (e.g. a wallet, widget, wallet container, wallet applet and the like as are described herein) may reference the network information and possibly service provider information provided during the NFC transaction to identify and activate one or more service elements, such as widgets to facilitate continuation of the single transaction over the second wireless network. It is noted that the network information may be sufficient to identify and activate an appropriate service provider-specific widget if a reference table that is described herein above is utilized. Alternatively, the network information may include data or other information (e.g. a URL) that the mobile device should access upon authentication on the second wireless network. Using this other network information may result in further service provider details being delivered to the service elements on the mobile phone (e.g. by accessing the provided URL) that may facilitate identification and activation of a particular service element, such as a service provider-specific widget.

In the event that the default form of payment is acceptable by a transaction processor of the retail environment, the transaction may be completed through the transaction processor after the user has moved the mobile device away from the NFC terminal. As described herein, information that results in delivery of a receipt for the purchase through the second network may be the follow-on actions.

In the event that the retail environment and/or a service provider through which the retail environment performs transactions prefers a particular form of payment (e.g. a credit card issued by a banking function of the retail environment—a “store card”) or the default form of payment is not accepted, additional activities need to be performed between the mobile device wallet and the service provider to effect payment for the purchase. In such a scenario, a service provider-specific service element that is activated through use of second network information as described above or is specifically identified through information provided to the mobile device during the first network NFC tap transaction may be activated to select an alternate form of payment. This alternate form of payment may be accessed by a widget that has authority to access the form of payment through a wallet. Widget access rights and limitations related to form of payment access and use are described elsewhere and herein. Once the service provider accesses the mobile device over the second wireless network, a service workflow that may be known to the service provider and to the service provider-specific widget may be executed to change the form of payment to the preferred/alternate form of payment and complete the transaction.

In an alternate example of performing the electronic transaction over two distinct networks, a service provider widget or set of widgets may be requested via an exchange of transaction related information over the second wireless network. In this example, the widget may not be identified by the information received during the first network transaction exchange (e.g. NFC tap interaction). Instead, information that identifies the transaction that may be exchanged over the second wireless network may include a service provider-specific widget reference and/or a service workflow identifier that triggers activation of a service provider-specific widget to effect the change in form of payment and complete the purchase transaction. The second form of payment information may be a default form of payment information associated with the service provider-specific widget.

In another example, the electronic transaction may be completed using the service provider-specific widget to facilitate confirmation of the electronic transaction by presenting a branded transaction confirmation request to the user of the mobile device. A user response may then be forwarded to a service provider from which the service information was received. In another example, the electronic transaction may be completed using the service provider-specific widget to receive and store in the mobile wallet a branded receipt for the electronic transaction from a service provider from which the service information was received.

The above are only a few examples of the benefits and capabilities of combining the NFC paired Bluetooth transaction methods and systems described herein with the transactional services methods and systems of the present disclosure and including all documents incorporated herein. Other benefits, capabilities, services, and functionality of such combinations are contemplated and included herein.

The methods and systems described herein may be deployed in part or in whole through a machine that executes computer software, program codes, and/or instructions on a processor. The present invention may be implemented as a method on the machine, as a system or apparatus as part of or in relation to the machine, or as a computer program product embodied in a computer readable medium executing on one or more of the machines. In embodiments, the processor may be part of an ASIC, FPGA, server, cloud server, client, network infrastructure, mobile computing platform, stationary computing platform, or other computing platform. A processor may be any kind of computational or processing device capable of performing information processing, executing program instructions, codes, binary instructions and the like. The processor may be or may include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes or may have no threads, programs, or codes. Any such threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor, or any machine utilizing one, may include memory that stores methods, codes, instructions and programs as described herein. The processor may access a storage medium through an interface that may store methods, codes, and instructions as described herein. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server, cloud server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein may be executed by one or more of the network infrastructural elements. The methods and systems described herein may be adapted for use with any kind of private, community, or hybrid cloud computing network or cloud computing environment, including those which involve features of software as a service (SaaS), platform as a service (PaaS), and/or infrastructure as a service (IaaS).

The methods, program codes, and instructions described herein may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps associated therewith, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, methods described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

What is claimed is:

1. A method for providing a service from a service provider to a user of a mobile device via a service provider-specific widget, wherein providing is performed over a private wireless network after authenticating access to the private wireless local area network using network authentication credentials delivered to a mobile wallet executing on the mobile device during an NFC tap of the mobile device with an NFC terminal that is disposed within access range of the private wireless local area network.

2. A method for providing a service from a service provider to a user of a mobile device via a service provider-specific widget, wherein providing is performed over a private wireless network after authenticating access to the private wireless local area network using network authentication credentials received by a mobile wallet executing on the mobile device from a QR code captured by the mobile device while the mobile device is disposed within access range of the private wireless local area network.
